(19) United States
(12) Patent Application Publication
(10) Pub. No.: US 2026/0249311 A1
(43) Pub. Date: Aug. 27, 2026

(54) CYCLONE SEPARATOR APPARATUS AND INSERT APPARATUS THEREFOR

(71) Applicant: 2691269 Alberta Inc., Strathmore (CA)

(72) Inventor: Ryan Thomas Bowley, Strathmore (CA)

(21) Appl. No.: 19/191,610

(22) Filed: Apr. 28, 2025

Related U.S. Application Data
(60) Provisional application No. 63/761,764, filed on Feb. 21, 2025.
(60) Provisional application No. 63/767,804, filed on Mar. 6, 2025.

(51) Int. Cl. B04C 11/00; B04C 7/00

(52) U.S. Cl. CPC B04C 11/00; B04C 7/00

(57) ABSTRACT

An insert is arranged for mounting in a cyclone separator having a cyclone separating chamber and at least one inlet tube introducing flow tangentially into the chamber. The insert has an insert body for mounting within an upper portion of the cyclone separating chamber and a flow passage for each inlet tube in which the flow passage extends downwardly through the insert body from an inlet opening aligned with the inlet tube to a discharge opening of the flow passage arranged for directing the flow helically into the cyclone chamber below. The cyclone incoming flow characteristics can thus be adjusted by selecting an insert with desired flow passage characteristics. When there are two inlet tubes of different size, the cyclone separating chamber is operable with one or both of the inlet tubes being opened to receive the incoming flow at 3 distinct speeds depending upon which inlet tubes are active.

This application claims the benefit under 35 U.S.C. 119(e) of U.S. provisional application Ser. Nos. 63/761,764, filed Feb. 21, 2025 and 63/767,804, filed Mar. 6, 2025.

### FIELD OF THE INVENTION

The present invention relates to a cyclone separator apparatus arranged to separate materials using a cyclonic flow, and more particularly the present invention relates to a cyclone separator apparatus configured so that incoming flow characteristics such as flow velocity, shape and/or direction can be readily adjusted.

### BACKGROUND

Normally cyclones or hydro cyclones are designed for one specific and controlled application. The dimensions and features of the cyclone are shaped and sized to ensure the proper fluid speed, dwell time and other factors such as cone length and angle, vortex finder position, underflow tube diameter and length and exit tube diameter among others.

These dimensions are all important to achieve the targeted separation efficiency for a given set of flow parameters.

Secondly most cyclones and hydro cyclones operate at relatively low pressures. Many gaseous cyclones operate in a partial vacuum rather than under pressure.

Oil and gas well applications are a special case and there are two main technical barriers to designing a high efficiency cyclone.

The first barrier is the flow of a well is not known before hand and varies greatly during the operation of that well and tends to increase initially and then decrease over time. Although every effort is taken to properly size a cyclone before installation the flow parameters are often a best guess and can turn out to be much different than was estimated and almost certainly will flow outside of the ideal for a significant portion of time that the cyclone is installed on the well.

The second barrier is that cyclones in oil and gas applications have to be built to handle high operating pressures and as such fall into the pressure vessel category of engineering design. There are several different engineering codes that limit the shape, wall thickness and nozzle locations such as API, ANSI and ABSA among others. For the most part the interior is circular and the inlet holes that penetrate the vessel are also circular, and their location is limited to ensure proper structural integrity to contain the high pressures.

As represented in FIG. 1, various prior art inlet configurations are represented schematically. Generally, the inlet shape is preferred to be rectangular and where possible, a spiral, or better yet a helical inlet, is best to introduce the flow with the least turbulence. In some cases, axial flow is used but not in the illustrated examples.

Because of pressure vessel engineering code, oil field cyclones almost always use a generally tangential inlet which is typically not located on the actual tangent due to code limitations. The inlet is typically required to be circular in cross section. More advanced and desired cyclones use helical inlets with a non-circular inlet shape, but this results in an increase in complexity and cost associated with the manufacture of the cyclone.

### SUMMARY OF THE INVENTION

According to one aspect of the present invention there is provided an insert apparatus for a cyclone separator including a cyclone body having (i) a cyclone separating chamber defined by a boundary wall surrounding a central axis and (ii) an inlet tube mounted on the cyclone body to introduce flow tangentially into the cyclone chamber in which the inlet tube has a prescribed cross-sectional area, the insert apparatus comprising:
an insert body arranged to be mounted within an upper portion of the cyclone separating chamber; and
a flow passage extending downwardly through the insert body from an inlet opening of the flow passage arranged for alignment with the inlet tube to a discharge opening of the flow passage arranged for communication with the cyclone chamber below the insert body.

Preferably the flow passage defines a reduced cross-sectional area which is reduced relative to the prescribed cross-sectional area of the inlet tube.

The insert body may be generally cylindrical in shape so as to occupy a full diameter of the upper portion of the cyclone separating chamber adjacent a top end of the cyclone separating chamber.

Preferably the insert body includes a central passage extending upwardly through the insert body to receive an outlet of the cyclone separating chamber communicating therethrough, in which the flow passage does not communicate with the central passage.

Preferably, the inlet opening has an inlet shape corresponding to a shape of the inlet tube on the cyclone body, and wherein the flow passage changes in shape from the inlet shape to a different shape along a length of the flow passage.

The flow passage preferably follows a helical path between the inlet opening and the discharge opening of the flow passage.

The flow passage may be fully enclosed between the inlet opening and the discharge opening when the insert body is received within the cyclone separating chamber. In the illustrated embodiments, the boundary of the flow passage is at least partly defined by the boundary wall of the cyclone separating chamber when the insert body is received within the cyclone separating chamber to enclose the flow passage.

Preferably the inlet opening of the flow passage has a flow area which is sized and shaped to correspond with a flow area of the inlet tube, in which the flow passage is then reduced in flow area to define said reduced cross-sectional area at a location between the inlet opening and the discharge opening.

The cross-sectional area of the flow passage is preferably gradually reduced from the prescribed cross-sectional area of the inlet tube to the reduced cross-sectional area over a portion of a length of the flow passage. In the illustrated embodiments, a portion of a length of the flow passage remains constant in cross-sectional area.

The cyclone separator may include a second inlet tube arranged to introduce flow tangentially into the cyclone chamber, and wherein the insert body including a second flow passage extending downwardly through the insert body from a second inlet opening of the second flow passage arranged for alignment with the second inlet tube to a second discharge opening of the second flow passage arranged for communication with the cyclone chamber below the insert body.

When the cyclone separator has two inlet tubes, preferably at least one of the flow passages in the insert body has a cross-sectional flow area that is reduced relative to the respective inlet tube. The flow passages in the insert body may have the same or different minimum cross-sectional flow areas relative to one another.

The insert apparatus may comprise a set of a plurality of insert bodies arranged to be interchangeably mounted within the upper portion of the cyclone separating chamber, in which the cross-sectional flow areas of the flow passages of the insert bodies differ from one another between different ones of the insert bodies.

When the cyclone separator has two inlet tubes, preferably at least one of the inlet tubes is operable between an open configuration and a closed configuration in which the cyclone separating chamber is operable with one or both of the inlet tubes being operable to receive the incoming flow. Preferably each flow passage follows a helical path between the inlet opening and the discharge opening of the flow passage such that the discharge opening communicates through a bottom boundary of the insert body.

The insert apparatus is inserted into the cyclone body where it mounts at the top of the cyclone body. This apparatus takes the incoming flow from the inlet diameter and reduces the area of the flow down gradually to a more appropriate shape as it is guided through a helical channel created by the insert and the cyclones inner wall where it is output into the cyclone working area from the top.

During the path the helical chamber can change both in its cross-sectional shape and cross-sectional area providing a better flow at a modified speed.

Although this device uses up some useful space within the cyclone body the change in speed and smooth entry of the flow as entering the rest of the working body increases the separation efficiency of the device over what it would have achieved if the device was not installed.

When there is a reduction in the flow area of the passage, the insert apparatus is to be installed in cyclones where the speed is not reaching the desired speed such that the insert apparatus effectively increases or decreases the speed of the given flow to more useful velocities while also reshaping the inlet cross sectional shape to reduce fluid dynamic losses and turbulence.

The inlet of the helical insert device is relocated at to enter at the top of the cyclone chamber rather than the side wall. Prior art cyclones have had multiple inlets in an array around the cyclone. Generally, these inlets all operate at the same time because their location on the side wall would cause a significant fluid dynamic disturbance if a non flowing hole was on the side wall. However, since the entry on this device is relocated to the roof or top of the cyclone this area is not as affected by the rotating flow of the cyclone and in general gases would fill the upper cavities providing a gaseous boundary for the liquids to flow under. This device can have a second or any reasonable number of multiple inlets added which when turned off do not obstruct the flow of the cyclone in a material way. In the case of two inlets which are of different sizes with a helical insert device can allow for 3 unique flow areas being achieved by opening or closing the two inlets. If the two cyclone inlets are of the same size the helical cyclone insert can be designed with two different channels of different cross-sectional areas and shapes to achieve two different effective inlet sizes. If the inlets are already of different sizes the helical insert devices and use cross sectional areas that are similar to the inlets to maintain that size difference of change either of those cross section to suit the needs of the expected conditions. In the case of three inlets 7 speed options exist and so on. And lastly you could have all the inlets be the same size and simply provide a longer wear life of the cyclone by changing which inlet you are using for a certain period of time.

According to a second aspect of the present invention there is provided a cyclone separator apparatus comprising:
a cyclone body having a cyclone separating chamber defined by a boundary wall surrounding a central axis; and
a plurality of inlet tubes mounted on the cyclone body to introduce an incoming flow at least partly tangentially into the cyclone chamber in which the inlet tubes have respective prescribed minimum cross-sectional flow areas;
wherein at least one of the inlet tubes is operable between an open configuration and a closed configuration such that the cyclone separating chamber is operable with a different number of the inlet tubes being operable to receive the incoming flow.

The inlet tubes may be mounted on the cyclone body to introduce the incoming flow helically into the cyclone chamber. Multiple inlet cyclones are not new but normally all inlets are required to be in operation at all times. Because the inlets come in on the outside wall of a cyclone having a non flowing inlet would cause flow related problems due to the hole in the side wall causing turbulence with the passing flow. The helical incoming flow reduces turbulence in the event that one of the inlet tubes is not in operation.

When an insert body is added into the cyclone, the normally tangential inlets are accepted into the insert where they are taken down a helical path so the flow enters at the top of the cyclone rather than the sides. During this path the cross section may be reduced to achieve the desired effective diameter. Although there is some disturbance to flow by the top opening, it is generally in the gaseous zone as the heavier fluids are forced to the exterior wall and as such does not have as much of an effect on separation performance if at all.

In some embodiments, the prescribed minimum cross-sectional flow area of at least one of the inlet tubes is different from one or more other ones of the inlet tubes. In this manner, the device allows 3 distinct speeds to be chosen during operation by simply opening and closing the inlets to suite the situation. More particularly, it allows for the option to open or close one of the inlets giving 3 overall scenarios: (i) Inlet A open, inlet B closed; (ii) Inlet B open, inlet A closed; or (iii) both inlets A and B open. If inlet A and B are of different sizes, then 3 distinct inlet areas can be created. If inlet A and B are the same size 2 distinct inlet areas can be created.

The cyclone can also be designed with 2 inlets of equal size but the insert body to speed flow can adjust the cross section of the flow path to achieve the same result. This option gives more flexibility as these inserts are selectable.

Also having two inlets of the same size could be useful for long wells so that one inlet could be used for the first period of time and the second inlet could be used for the second period of time to reduce the wear on areas where it is focused.

### BRIEF DESCRIPTION OF THE DRAWINGS

Some embodiments of the invention will now be described in conjunction with the accompanying drawings in which:

FIG. 1 is a schematic representation of various prior art configurations of cyclone separators of the type operated at high pressure in the oil and gas industry for separating lighter hydrocarbon fluids from denser sand materials;

FIG. 2 is a schematic front elevational view of a typical cyclone separator arranged to receive an insert apparatus according to the present invention;

FIG. 3 is a schematic side elevational view of the cyclone separator of FIG. 2;

FIG. 4 is a sectional view along the line 4-4 in FIG. 3;

FIG. 5 is a schematic front elevational view of the cyclone separator according to FIG. 2, shown with the insert apparatus according to a first embodiment of the present invention inserted therein;

FIG. 6 is a schematic side elevational view of the cyclone separator of FIG. 5;

FIG. 7 is a sectional view along the line 7-7 in FIG. 6;

FIG. 8 is a perspective view of a top side of the insert apparatus according to the first embodiment of FIG. 5;

FIG. 9 is a side elevational view of the insert apparatus of FIG. 8;

FIG. 10 is a rear elevational view of the insert apparatus of FIG. 8;

FIG. 11 is a front elevational view of the insert apparatus of FIG. 8;

FIG. 12 is a side elevational view of the insert apparatus of FIG. 8, shown from the opposing side as FIG. 9;

FIG. 13 is a perspective view of a bottom side of the insert apparatus of FIG. 8;

FIG. 14 is a front elevational view of a second embodiment of the insert apparatus for mounting in the cyclone separator according to FIG. 5;

FIG. 15 is a schematic elevational view of the cyclone separator according to the second embodiment of FIG. 14;

FIG. 16 is a schematic plan view of the cyclone separator according to the second embodiment of FIG. 14;

FIG. 17 is an elevational view of a second embodiment of the cyclone separator including two inlet tubes;

FIG. 18 is a sectional view along the line 18-18 in FIG. 17;

FIG. 19 is a front elevational view of an alternative insert apparatus received within the cyclone separator according to the embodiment of FIG. 17;

FIG. 20 is a left side view of the insert apparatus of FIG. 19;

FIG. 21 is a right side view of the insert apparatus of FIG. 19;

FIG. 22 is a sectional view along the line 22-22 in FIG. 19;

FIG. 23 is a bottom view of the insert apparatus of FIG. 19;

FIG. 24 is a schematic perspective view of the cyclone separator according to a further embodiment;

FIG. 25 is a sectional view of the insert apparatus within the cyclone separator according to the embodiment of FIG. 24;

FIG. 26 is a schematic perspective view of the cyclone separator according to a further embodiment; and

FIG. 27 is a sectional view of the insert apparatus within the cyclone separator according to the embodiment of FIG. 26.

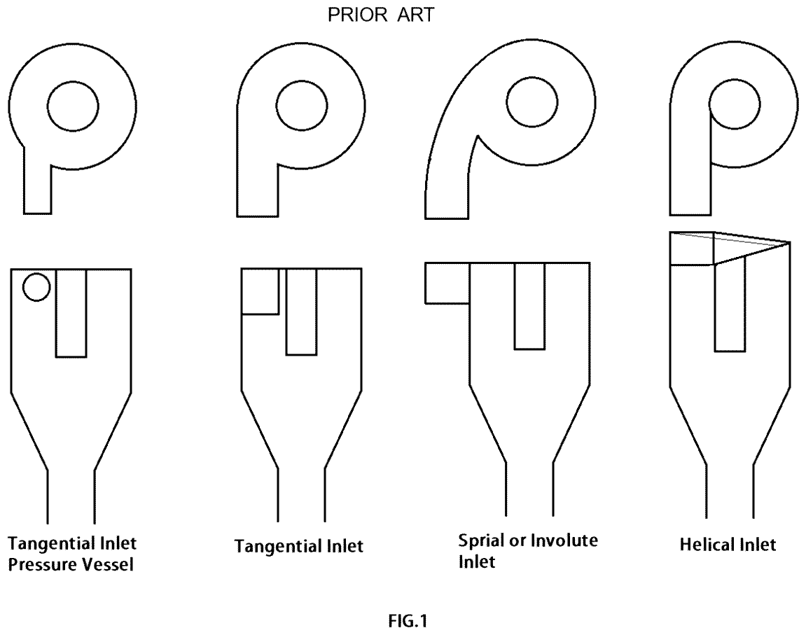

In the drawings like characters of reference indicate corresponding parts in the different figures.

### DETAILED DESCRIPTION

Referring to the accompanying figures there is illustrated a cyclone separator apparatus generally indicated by reference numeral 10. Although various embodiments are illustrated, the features in common with the various embodiments will first be described.

In each instance, the cyclone separator 10 generally includes a cyclone body 12 defining a cyclone separating chamber 14 therein. The cyclone body defines the boundary walls of the chamber which include a cylindrical portion 16 adjacent a top end 18 of the chamber which is mounted concentrically about an upright vertical axis of the chamber. The boundary wall further includes a conical portion 20 immediately below the cylindrical portion so that the boundary wall tapers downwardly and inwardly from the bottom of the cylindrical portion to a bottom discharge 22 centrally located at the bottom end of the chamber 14. The bottom discharge 22 comprises an underflow tube which discharges into an accumulator chamber 24 below the cyclone separating chamber 14. The top end 18 of the chamber is enclosed by a circular top boundary wall 28 spanning horizontally across the top of the cylindrical portion 16.

The cyclone separator 10 further includes a top discharge 26 in the form of a vortex finder and overflow tube which is aligned with the central axis of the separating chamber 14 in open communication with the chamber so as to allow lighter fluids separated in the chamber to be discharged upwardly through the top discharge 26 which communicates upwardly through the top boundary wall 28 of the chamber.

The cyclone separator 10 includes at least one inlet tube 30 mounted on the cyclone body to communicate through the boundary wall in alignment with the cylindrical portion 16 and adjacent the top boundary 28 at the top end 18 of the separating chamber. Each inlet tube 30 is oriented generally tangentially at the peripheral boundary of the separating chamber so as to define an inlet passage extending through the inlet tube in open communication with the cyclone separating chamber. The inlet passage of each inlet tube 30 has a circular cross-section which is constant in diameter so that the prescribed cross-sectional area of the inlet tube 30 defines a flow area of a corresponding flow through the inlet tube into the separating chamber.

In operation, an incoming flow to be separated is introduced into the separating chamber 14 through the at least one inlet tube 30 to produce a cyclonic flow within the chamber. In this manner heavier materials in the incoming flow are urged towards the boundary wall to be gradually discharged by gravity through the bottom discharge 22 into the accumulator chamber 24 below, while lighter materials in the incoming flow gather at a central location within the chamber for discharge upwardly through the central top discharge tube 26.

In most embodiments described herein, an insert apparatus 32 is mounted within an upper portion of the cylindrical portion 16 of the separating chamber 14 adjacent the top end 18 thereof. The insert apparatus 32 generally includes an insert body 34 which is generally cylindrical in shape so as to have an outer diameter which is approximately equal to the inner diameter of the cylindrical portion of the cyclone separating chamber. The height of the cylindrical body only occupies the upper portion of the cylindrical portion of the chamber that is in alignment with the one or more inlet tubes 30.

A central passage 36 extends through the insert body coaxially with the cylindrical shape for alignment with the top discharge tube 26 of the cyclone chamber that is received therethrough. The inner diameter of the central passage 26 is approximately equal to the outer diameter of the top discharge tube 26 so that the outlet of the cyclone chamber can communicate upwardly through the central passage 36 of the insert body for discharging lighter materials through the top discharge 26 in the usual manner.

The insert body 34 is typically mounted in fixed relation to the cyclone body by various means of mechanical coupling, for example between the insert body and the boundary wall of the chamber, between the insert body and the top discharge tube 26, or between the insert body and an upper boundary wall 28 of the cyclone chamber.

The insert apparatus 32 further includes at least one flow passage 38 extending helically downwardly through the insert body from a respective inlet opening 40 of the flow passage at a side boundary of the cylindrical insert body to a respective discharge opening 42 at a bottom boundary of the insert body in open communication with the remainder of the cyclone separating chamber therebelow. The inlet opening 40 of each flow passage is sized and positioned for alignment with the inlet passage of a corresponding one of the inlet tubes 30 of the cyclone separator 10. In this manner the cross-sectional flow area, shape and interior diameter of the inlet opening of each flow passage 38 of the insert apparatus 32 is approximately equal to the corresponding cross-sectional flow area, shape and inner diameter of the inlet passage through the corresponding inlet tube 30 with which the flow passage is aligned in the mounted position of the insert apparatus 32 within the cyclone chamber.

Each flow passage 38 includes an inlet section 44 which is gradually tapered and gradually reduced in cross-sectional flow area from the inlet opening matching the cross-sectional flow of the corresponding inlet tube 30 to a main section 46 of the flow passage defining a reduced cross-sectional flow area which is reduced relative to the prescribed flow area of the inlet tube 30. The main section 46 of the flow passage typically remains constant in cross-sectional flow area from the inlet section 44 to the bottom discharge opening.

Each flow passage 38 is located directly against the cylindrical side boundary 48 of the insert body and is partly open to the side boundary. When the insert body is mounted within the cyclone body however, side boundaries of the flow passage are enclosed by the boundary wall of the cyclone separating chamber 14 so that the boundary wall of the cyclone separating chamber defines part of the boundary of the flow passage along part of the length of the flow passage. Once the insert body is mounted within the cyclone chamber, the flow passage is fully enclosed between the inlet opening adjacent the respective inlet tube 30 and the bottom discharge 22 at the bottom boundary of the insert body that is in open communication with the remainder of the cyclone separating chamber below the insert body.

As described herein, the insert apparatus 32, which can also be referred to as a helical cyclone speeder that accelerates and alters direction of incoming flow in some instances, is a device which is positioned at the top of a cyclone chamber where it accepts the incoming inlet flow at the incoming diameter of the inlet. The device has a gradually swept or lofted surface which reduces the area of the incoming inlet to the desired reduced cross-sectional flow area and brings that flow to the cylindrical side boundary of the cyclone separating chamber. The area then remains constant as the flow passage travels in a helical path downwardly and into the cyclone separating chamber below.

Turning now more particularly to the first embodiment shown in FIGS. 5 through 13, the cyclone separator 10 in this instance includes a single inlet tube 30 in which the inlet passage therethrough has a constant circular shape and a constant cross-sectional flow area along the length thereof as it is introduced into the separating chamber. The insert apparatus 32 in this instance accordingly has a single flow passage therein for alignment with the inlet tube 30 in the mounted position. The inlet opening 40 of the passage is circular and remains circular (i) as the cross-sectional flow area is reduced along the inlet section and (ii) throughout the main section 46 up to the discharge opening where flow passage opens through the bottom boundary of the insert body to communicate with the remainder of the separating chamber therebelow. The helical path of the flow passage extends approximately 360 degrees about the periphery of the insert body 34.

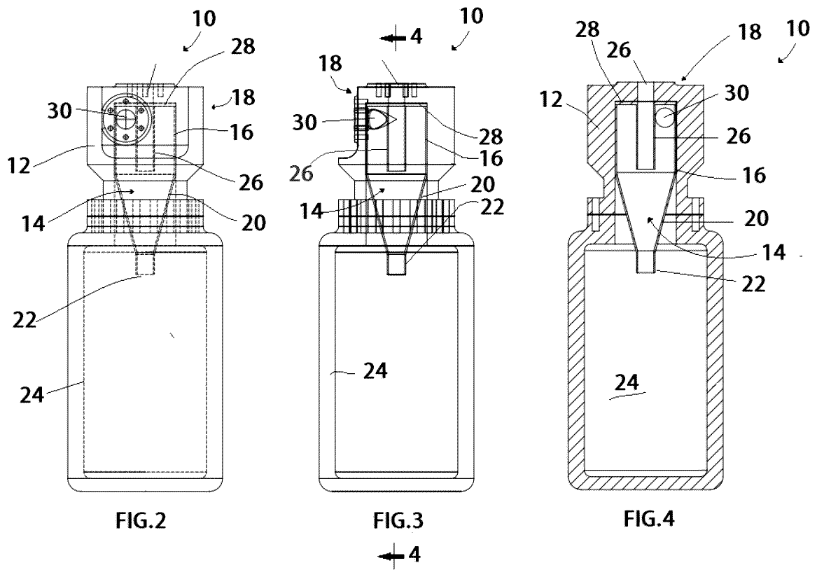

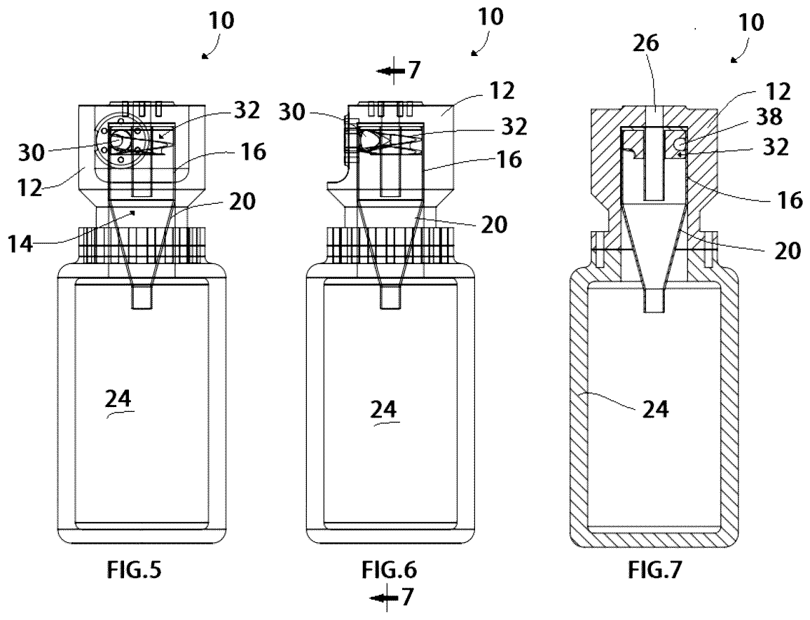

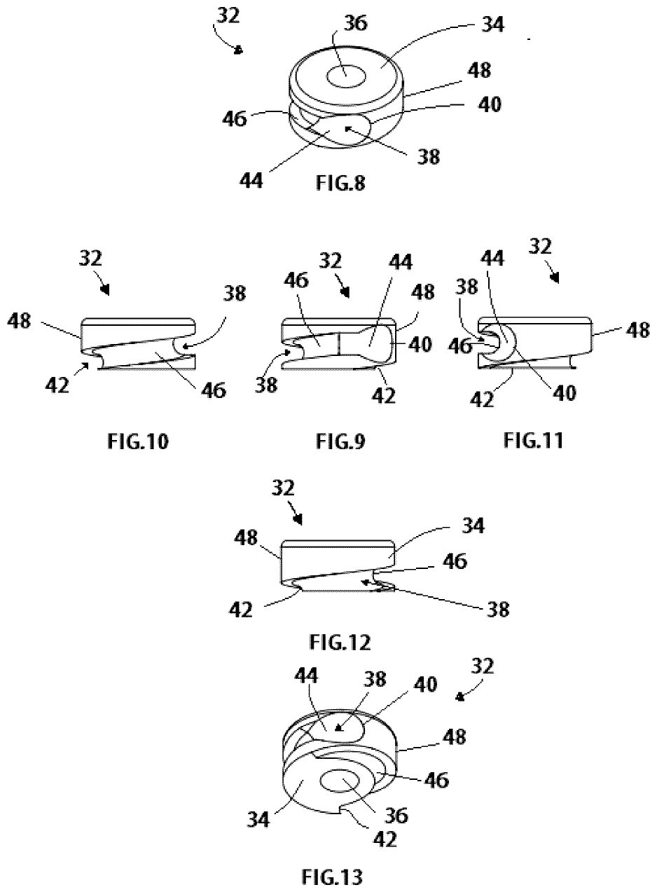

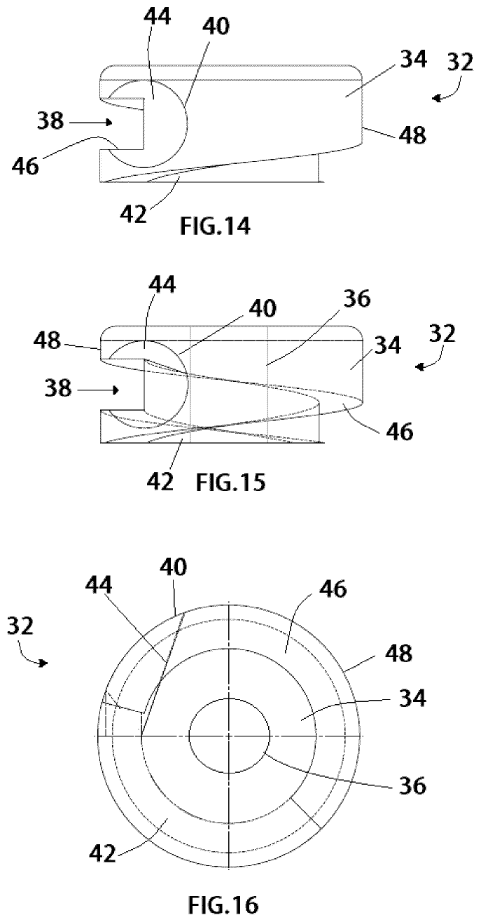

Turning now to the second embodiment of the insert apparatus 32 shown in FIGS. 14 through 16, the insert apparatus 32 in this instance is interchangeable with the insert apparatus of the previous embodiment so as to be mounted within the same cyclone separator 10 shown in FIGS. 2 through 7. The insert apparatus 32 in this instance is substantially identical to the previous embodiment with the exception of the flow passage changing in shape along the length thereof. As shown in the accompanying figures, the inlet opening 40 remains circular for matching the shape of the incoming inlet tube 30 with which the flow passage communicates, however, the circular shape transitions to a rectangular shape along the inlet section 44 and then maintains a rectangular shape along the main section 46. The outer boundary of the rectangular shape is again defined by the boundary wall of the separating chamber so that the flow entering through the flow passage transitions into a cyclonic flow within the remainder of the separating chamber below with a minimum amount of turbulence.

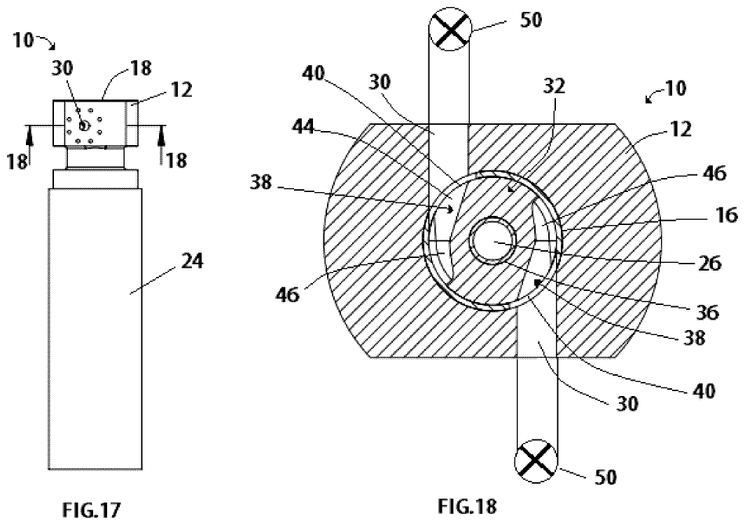

As shown in the embodiments of FIGS. 17 through 27, the cyclone separator 10 in each instance is provided with two inlet tubes 30 at diametrically opposing locations in which each inlet again communicates tangentially to the separating chamber by communicating with the separating chamber at diametrically opposed locations. Each inlet tube 30 in this instance is connected in series with an external valve 50 arranged for operation between open and closed states to selectively close off the corresponding inlet 30 to prevent incoming flow therethrough while maintaining the high operating pressure within the separating chamber.

The insert apparatus 32 in the embodiments of FIGS. 17 through 27 includes two flow passages 38 formed therein so as to be similarly diametrically opposed from one another. More particularly, the flow passages 38 have respective inlet openings 40 at diametrically opposed locations for alignment with respective ones of the two inlet tubes 30, while the passages extend helically from the inlet openings to the respective discharge openings 42 of the passages so that the helical paths are offset from one another by 180 degrees along the length of the passages. Each flow passage extends helically about 180 about the periphery of the insert body.

In the embodiment of FIGS. 17 and 18, the inlet tubes are substantially identical to one another in shape and size so as to define identical cross-sectional flow areas. The two flow passages of the insert apparatus 32 may also be identical to one another in size and shape. In a first mode of operation, both valves 50 can be opened so that flow is introduced through both inlet tubes 30 and through both corresponding flow passages of the insert apparatus 32. Alternatively, either one of the valves 50 can be closed so that flow is only introduced through one of the inlet tubes 30 followed by flow being introduced through the corresponding flow passage of the insert body while the other flow passage receives no incoming flow. The helical path of the active flow passage directs flow downwardly into the separating chamber below so that the inactive flow passage tends not to introduce excessive turbulence within the cyclonic flow within the separating chamber.

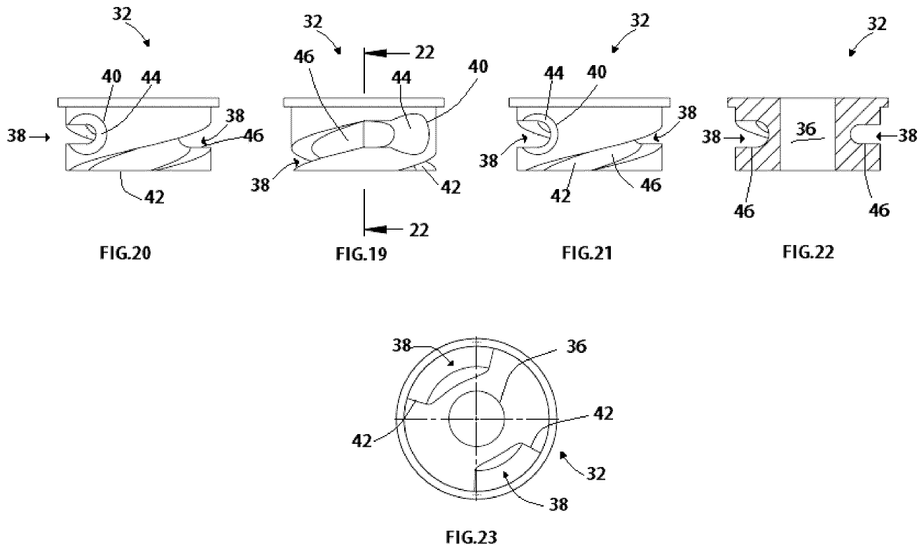

In the embodiment of FIGS. 19 through 23, an alternative insert apparatus 32 is illustrated which can be mounted within the upper portion of the separating chamber in place of the insert apparatus of FIGS. 17 and 18. In this instance, the two flow passages through the insert body 34 of the insert apparatus 32 define different minimum cross-sectional flow areas so as to have different flow characteristics relative to one another. When paired with the separating chamber 10 of FIGS. 17 and 18 in which the inlet passages of the inlet tubes 30 are identical to one another, the inlet openings 40 of the two flow passages 38 of the insert apparatus are identical to one another to pair with corresponding inlet tubes 30, however, the tapered reduction in cross-sectional flow area within the inlet sections 44 varies between the two flow passages such that the cross-sectional flow area of the two passages throughout the main sections 46 thereof as shown in cross-section in FIG. 22 are different from one another.

As opposed to the embodiment of FIGS. 17 and 18 in which only two separate flow conditions can be defined (that is one inlet tube and flow passage being operational or both inlet tubes and flow passages being operational) when the insert apparatus of FIGS. 19 through 23 is used within the cyclone separator 10, three different flow conditions can be achieved. The three flow conditions include (i) flow through a first inlet tube 30 and corresponding flow passage with the smallest cross-sectional flow area, (ii) flow through a second inlet tube 30 and corresponding flow passage with the largest cross-sectional flow area, and (iii) flow through both inlet tubes 30 and the corresponding flow passages to produce a maximum cross-sectional flow area introduced into the separating chamber.

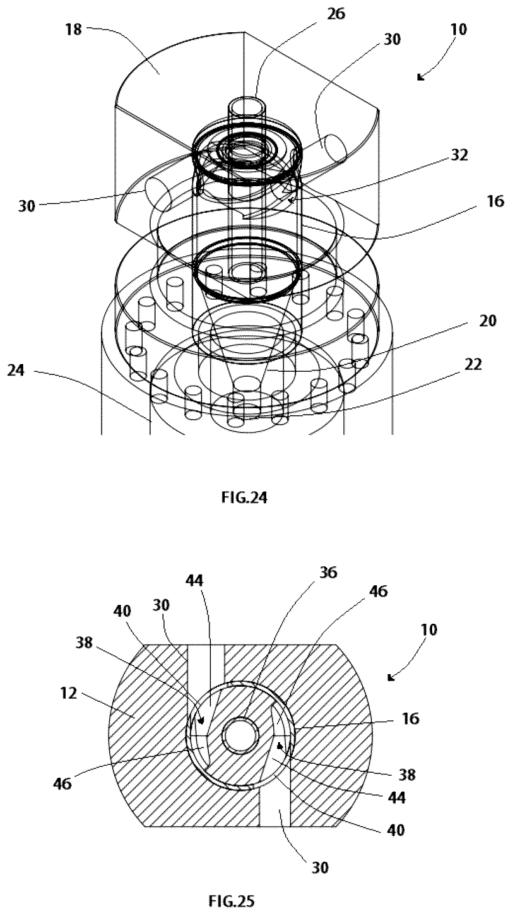

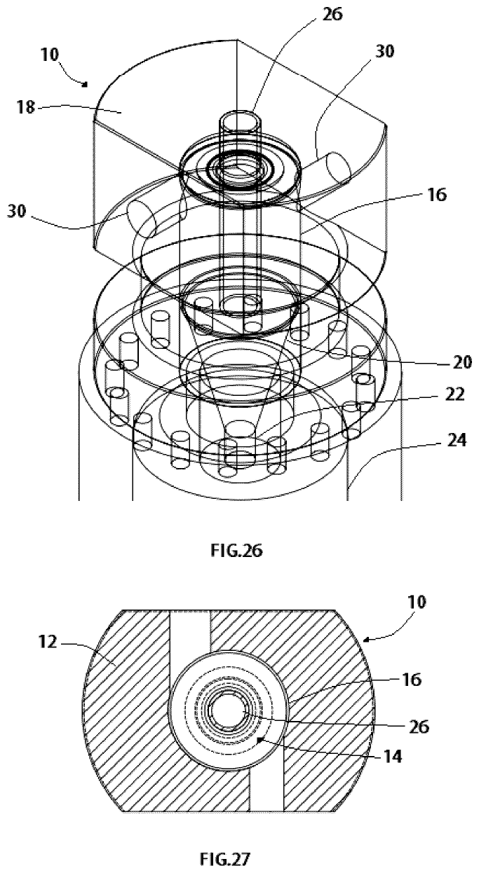

In the embodiment of the cyclone separator 10 of FIGS. 24 and 25, the two inlet tubes 30 have different diameters and corresponding different cross-sectional flow areas even if the flow passages through the insert apparatus 32 are identical to one another. Accordingly, three different flow conditions can be achieved similarly to the three flow conditions achieved above by only opening the valve 50 of the smaller inlet tube 30, only opening the valve 50 of the larger inlet tube 30, or opening both valves 50 to achieve maximum incoming flow. Further variation of the flow can be achieved by exchanging the insert apparatus 32 with a different insert apparatus having different flow passage configurations.

In a further embodiment shown in FIGS. 26 and 27, the cyclone body may be arranged with two inlet tubes 30 having different diameters and different cross-sectional flow areas similarly to the previous embodiment but with the cyclone separator being operational without the insert body 32 of the previous embodiments being mounted within the cyclone separating chamber. Again, three different flow conditions can be achieved depending upon the combination of valves 50 which are open and closed as described above. In this instance, it may be desirable to provide a plug within any inactive inlet tube so that the open end of the inactive inlet tube does not introduce excessive turbulence to the cyclonic flow within the separating chamber. In this instance, the plug may fully occupy the interior passage of the inlet tube and/or may include an innermost boundary surface that is arranged to lie substantially flush with the inside cylindrical boundary surface of the cyclone chamber such that the closed inlet tube does not interfere with cyclonic flow within the cyclone separating chamber when only one inlet tube is being used.

To minimize turbulence, in further embodiments the inlet tubes may be provided with a downward slope to introduce a helical path to the incoming flow entering the cyclonic separating chamber.

In all embodiments with two or more inlet tubes, one or more of the inlet tubes can be operated between an open configuration allowing flow therethrough and a closed configuration in which flow through the inlet tube is prevented. This may be accomplished by a high-pressure shut-off valve 50 mounted in communication with the inlet tube as described above, or with a cap that can be secured to an external flange of the inlet tube to close off the inlet tube as examples.

As described above, in some instances the inlet tubes have the same diameters and thus the same prescribed minimum cross-sectional flow area therethrough. Likewise, the flow passages in the insert body are similarly identical to one another so as to have similar prescribed minimum cross-sectional flow areas relative to one another, while being reduced relative to the flow through the inlet tubes of the cyclone separator body.

In further embodiments however, the flow passages through the insert body may differ relative to one another while having inlet openings that are identical for communicating with the identical diameters of the inlet tubes of the cyclone body.

Alternatively, as shown in some of the embodiments described above, one of the inlet tubes may have a reduced diameter relative to the other so that one of the inlet tubes has a smaller prescribed minimum cross-sectional flow area. The insert body is configured so that the inlet openings of the two flow passages are aligned with and substantially equal in size, shape and configuration to respective ones of the inlet tubes of the cyclone body, while being tapered to reduce to different sizes so that the prescribed minimum cross-sectional flow areas are again different from one another.

In further embodiments, a plurality of insert bodies may be provided each having flow passages arranged for alignment with respective ones of the inlet tubes in which the flow passages are different in configuration from one another and different in configuration from the flow passages of other insert bodies. The insert bodies can all be interchangeable with one another so that mounting a different selected one of the insert bodies varies the flow characteristics through one or both of the inlet tubes of the cyclone separator.

In further embodiments, the insert body received within the upper portion of the cyclone chamber may be interchangeable with an auxiliary insert body having only a single flow passage extending helically downward therethrough from an inlet opening to a discharge opening as described above for alignment with the flow passage with only one of the inlet tubes that is operating in the open configuration so that the remainder of the insert body acts as a plug which blocks off the communication of the closed inlet tube relative to the cyclone separating chamber.

When using an insert body with multiple flow passages in communication with multiple inlet tubes of the cyclone body respectively, simply closing the inlet tube at an external location, for example by a valve or cap as described above, may be sufficient without any plugging of the unused flow passages in the insert body being required because the location of the discharge openings in a bottom surface of the insert body rather than at a cylindrical boundary of the cyclone chamber is less disruptive to the cyclonic flow within the separating chamber.

In further embodiments, the cyclone separator may include more than two inlet tubes such as three, four, five or more inlet tubes in which each of the inlet tubes can be operated between open and closed positions while the cyclone chamber remains operational using the remaining open inlet tubes. When using an insert body, the insert body would again have a helical flow passage extending therethrough in communication with each one of the inlet tubes respectively.

Since various modifications can be made in the invention as herein above described, and many apparently widely different embodiments of same made, it is intended that all matter contained in the accompanying specification shall be interpreted as illustrative only and not in a limiting sense.

1. An insert apparatus for a cyclone separator including a cyclone body having (i) a cyclone separating chamber defined by a boundary wall surrounding a central axis and (ii) an inlet tube mounted on the cyclone body to introduce flow tangentially into the cyclone separating chamber in which the inlet tube has a prescribed cross-sectional area, the insert apparatus comprising:
an insert body arranged to be mounted within an upper portion of the cyclone separating chamber; and
a flow passage extending downwardly through the insert body from an inlet opening of the flow passage arranged for alignment with the inlet tube to a discharge opening of the flow passage arranged for communication with the cyclone chamber below the insert body.

2. The insert apparatus according to claim 1 wherein the flow passage defines a reduced cross-sectional area which is reduced relative to the prescribed cross-sectional area of the inlet tube.

3. The insert apparatus according to claim 1 wherein the insert body is generally cylindrical in shape so as to occupy a full diameter of the upper portion of the cyclone separating chamber adjacent a top end of the cyclone separating chamber.

4. The insert apparatus according to claim 1 wherein the insert body includes a central passage extending upwardly through the insert body to receive an outlet of the cyclone separating chamber communicating therethrough, wherein the flow passage does not communicate with the central passage.

5. The insert apparatus according to claim 1 wherein the inlet opening has an inlet shape corresponding to a shape of the inlet tube on the cyclone body, and wherein the flow passage changes in shape from the inlet shape to a different shape along a length of the flow passage.

6. The insert apparatus according to claim 1 wherein the flow passage follows a helical path between the inlet opening and the discharge opening of the flow passage.

7. The insert apparatus according to claim 1 wherein the flow passage is fully enclosed between the inlet opening and the discharge opening when the insert body is received within the cyclone separating chamber.

8. The insert apparatus according to claim 7 wherein a flow boundary of the flow passage is at least partly defined by the boundary wall of the cyclone separating chamber when the insert body is received within the cyclone separating chamber.

9. The insert apparatus according to claim 1 wherein the inlet opening of the flow passage has a flow area which is sized and shaped to correspond with a flow area of the inlet tube, the flow passage being reduced in flow area to define said reduced cross-sectional area at a location between the inlet opening and the discharge opening.

10. The insert apparatus according to claim 1 wherein a cross-sectional area of the flow passage is gradually reduced from the prescribed cross-sectional area of the inlet tube to the reduced cross-sectional area over a portion of a length of the flow passage.

11. The insert apparatus according to claim 1 wherein a portion of a length of the flow passage is constant in cross-sectional area.

12. The insert apparatus according to claim 1 wherein the cyclone separator includes a second inlet tube arranged to introduce flow tangentially into the cyclone chamber, and wherein the insert body including a second flow passage extending downwardly through the insert body from a second inlet opening of the second flow passage arranged for alignment with the second inlet tube to a second discharge opening of the second flow passage arranged for communication with the cyclone chamber below the insert body.

13. The insert separator apparatus according to claim 12 wherein at least one of the flow passages in the insert body has a cross-sectional flow area that is reduced relative to the respective inlet tube.

14. The insert separator apparatus according to claim 12 wherein the flow passages in the insert body have different minimum cross-sectional flow areas relative to one another.

15. The insert separator apparatus according to claim 12 further comprising a plurality of insert bodies arranged to be interchangeably mounted within the upper portion of the cyclone separating chamber, in which the cross-sectional flow areas of the flow passages of the insert bodies differ from one another between different ones of the insert bodies.

16. The insert separator according to claim 12 in combination with the cyclone separator, wherein at least one of the inlet tubes is operable between an open configuration and a closed configuration and wherein the cyclone separating chamber is operable with one or both of the inlet tubes being operable to receive the incoming flow.

17. The insert apparatus according to claim 12 wherein each flow passage follows a helical path between the inlet opening and the discharge opening of the flow passage such that the discharge opening communicates through a bottom boundary of the insert body.

18. A cyclone separator apparatus comprising:
a cyclone body having a cyclone separating chamber defined by a boundary wall surrounding a central axis; and
a plurality of inlet tubes mounted on the cyclone body to introduce an incoming flow at least partly tangentially into the cyclone chamber in which the inlet tubes have respective prescribed minimum cross-sectional flow areas;
wherein at least one of the inlet tubes is operable between an open configuration and a closed configuration such that the cyclone separating chamber is operable with a different number of the inlet tubes being operable to receive the incoming flow.

19. The cyclone separator apparatus according to claim 18 wherein the inlet tubes are mounted on the cyclone body to introduce the incoming flow helically into the cyclone chamber.

20. The cyclone separator apparatus according to claim 18 wherein the prescribed minimum cross-sectional flow area of at least one of the inlet tubes is different from one or more other ones of the inlet tubes.

21. The cyclone separator apparatus according to claim 18 further comprising a plug member arranged to be received within one of the inlet tubes when that inlet tube is in the closed configuration so as to minimize turbulence in the cyclone separating chamber at an intersection of that inlet tube with a boundary of the cyclone separating chamber.
